(19) United States
(12) Patent Application Publication
(10) Pub. No.: US 2024/0056868 A1
(43) Pub. Date: Feb. 15, 2024

(54) METHOD AND APPARATUS TO COLLECT DATA FOR NETWORK DATA ANALYSIS IN MOBILE COMMUNICATION SYSTEM

(71) Applicant: Samsung Electronics Co., Ltd., Suwon-si (KR)

(72) Inventors: Jungshin PARK, Suwon-si (KR); Hyesung KIM, Suwon-si (KR); Dongeun SUH, Suwon-si (KR)

(21) Appl. No.: 18/447,119

(22) Filed: Aug. 9, 2023

(30) Foreign Application Priority Data
Aug. 9, 2022 (KR) 10-2022-0099565

(51) Int. Cl. H04W 28/02; H04W 24/10

(52) U.S. Cl. CPC H04W 28/0236; H04W 24/10

(57) ABSTRACT

The disclosure relates to a 5G or 6G communication system for supporting a higher data transmission rate. A method performed by a first network data collection and analysis function (NWDAF) entity in a mobile communication system is provided. The method comprises transmitting, to a network entity for collecting management information, a first request message for collection of first management information for a network function (NF) entity, receiving, from the network entity, the first management information for the NF entity and identifying a result of an analysis for the NF entity based on the first management information for the NF entity.

### CROSS-REFERENCE TO RELATED APPLICATION

This application is based on and claims priority under 35 U.S.C. § 119 to Korean Patent Application No. 10-2022-0099565, filed on Aug. 9, 2022, in the Korean Intellectual Property Office, the disclosure of which is herein incorporated by reference in its entirety.

### BACKGROUND

### 1. Field

The disclosure relates to a mobile communication system, more particularly to a method and an apparatus for collecting and analyzing data of a network in a mobile communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission di stances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure provides an apparatus and a method for providing a service effectively in a radio communication system.

A method performed by a first network data collection and analysis function (NWDAF) entity in a mobile communication system is provided. The method comprises transmitting, to a network entity for collecting management information, a first request message for collection of first management information for a network function (NF) entity, receiving, from the network entity, the first management information for the NF entity and identifying a result of an analysis for the NF entity based on the first management information for the NF entity.

A first network data collection and analysis function (NWDAF) entity in a mobile communication system is provided. The first NWDAF entity comprises a transceiver and a controller coupled with the transceiver and configured to transmit, to a network entity for collecting management information, a first request message for collection of first management information for a network function (NF) entity, receive, from the network entity, the first management information for the NF entity and identify a result of an analysis for the NF entity based on the first management information for the NF entity.

A method performed by a network entity for collecting management information in a mobile communication system is provided. The method comprises receiving, from a first network data collection and analysis function (NWDAF) entity, a first request message for collecting first management information for a network function (NF) entity and transmitting, to the first NWDAF entity, the first management information for the NF entity. A result of an analysis for the NF entity is based on the first management information for the NF entity.

A network entity for collecting management information in a mobile communication system is provided. The network entity comprises a transceiver and a controller coupled with the transceiver and configured to receive, from a first network data collection and analysis function (NWDAF) entity, a first request message for collecting first management information for a network function (NF) entity and transmit, to the first NWDAF entity, the first management information for the NF entity. A result of an analysis for the NF entity is based on the first management information for the NF entity.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a configuration of a radio communication network including a NWDAF according to an embodiment of the present disclosure;

FIG. 2 illustrates a signal flowchart of an operation in which a network function of a control plane which supports an interface with a network function of a management plane registers a NRF according to an embodiment of the present disclosure;

FIG. 3 illustrates a signal flowchart of an operation in which a network data analysis function receives a request for network data analysis from a consumer network function, collects data of a management plane, and delivers an analytics output to a consumer network function according to an embodiment of the present disclosure;

FIG. 4 illustrates a signal flowchart of an operation in which a data analysis function of a management plane generates an analytics output for use on the management plane according to an embodiment of the present disclosure;

FIG. 5 illustrates a structure of a base station according to an embodiment of the present disclosure;

FIG. 6 illustrates a structure of a UE according to an embodiment of the present disclosure; and

FIG. 7 illustrates a structure of a network entity according to an embodiment of the present disclosure.

### DETAILED DESCRIPTION

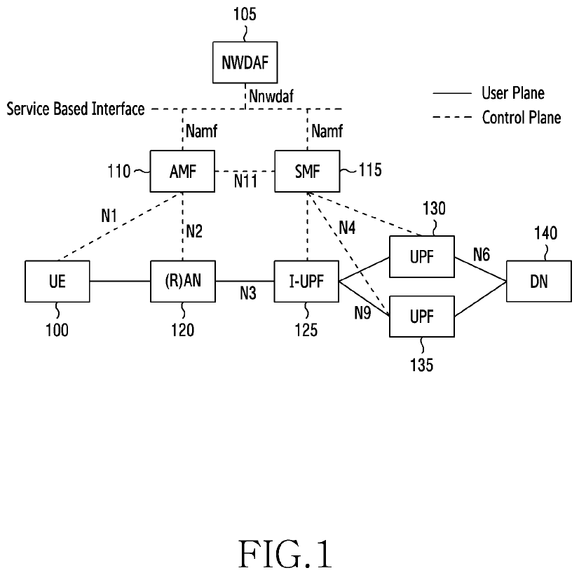

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments of the disclosure, detailed descriptions of well-known functions or configurations will be omitted since they would unnecessarily obscure the subject matters of the disclosure. Also, the terms used herein are defined according to the functions of the disclosure. Thus, the terms may vary depending on users' or operators' intentions or practices. Therefore, the terms used herein should be understood based on the descriptions made herein.

Some components in the accompanying drawings may be exaggerated, omitted, or schematically illustrated. In addition, the size of each component does not completely reflect a real size. The same reference numerals are used for the same or corresponding components in each drawing.

The advantages and features of the disclosure, and/or methods for achieving the features will be apparent by referring to embodiments, which will be described below in detail along with the accompanying drawings. However, the disclosure is not limited to embodiments disclosed hereinbelow, and may be embodied in many different forms. Embodiments disclosed hereinbelow are provided only to make the disclosure thorough and complete and fully convey the scope of the disclosure to those of ordinary skill in the art, and the disclosure may be defined only by the scope of the appended claims.

It will be understood that each block in the drawing showing process flowcharts and combinations of the process flowcharts may be performed by computer program instructions. The computer program instructions may be loaded into a processor of a generic-purpose computer, a special computer, or other programmable data processing equipment. Therefore, the instructions performed by the processor of the computer or other programmable data processing equipment may generate a means for performing functions explained in the block(s) of the flowcharts. The computer program instructions may be stored in a computer-usable or computer-readable memory which is directed at a computer or other programmable data processing equipment in order to implement a function in a specific method. Accordingly, the instructions stored in the computer-usable or computer-readable memory may produce a manufacturing item including an instruction means for performing functions explained in the block(s) of the flowcharts. The computer program instructions may be loaded on a computer or other programmable data processing equipment. Accordingly, a series of operation steps may be performed on the computer or other programmable data processing equipment to generate a process to be executed by the computer, and the instructions performing the computer or other programmable data processing equipment may provide steps for executing functions explained in the block(s) of the flowcharts.

In addition, each block may represent a part of a module, a segment or a code including one or more executable instructions for executing a specified logical function(s). It should be noted that, in some alternative examples, functions mentioned in blocks may be performed irrespective of an order. For example, two blocks which are successively illustrated may be performed substantially at the same time, or may be performed in the inverse order according to their corresponding functions.

The term “unit” or “part” used in the disclosure refers to a software component or a hardware component such as a field programmable gate array (FPGA) or an application specific integrated circuit (ASIC), and the “unit” may be configured to perform a certain role. However, the “unit” is not limited to software or hardware, The “unit” may be configured to exist in a storage medium which may address, and may be configured to execute one or more processors. For example, the “unit” may include components such as software components, object-oriented software components, class components and task components, and processes, functions, attributes, procedures, sub-routines, segments of a program code, drivers, firmware, microcode, circuit, data, database, data structures, tables, arrays, and variables. Functions provided in the components and the “units” may be coupled with fewer components and “units” or may further be divided into additional components and “units.” In addition, the components and the “units” may be implemented to reproduce one or more central processing units (CPUs) in a device or a security multimedia card. In addition, in an embodiment, the “unit” may include one or more processors.

In the disclosure, some of the terms and the names defined in 3rd generation partnership project (3GPP) long term evolution standards (5G, NR, LTE or standards of similar systems) are used for the convenience of explanation. However, the disclosure is not limited by the terms and the names, and may be equally applied to systems conforming to other standards.

As used herein, a term for identifying an access node, terms indicating network entities, terms indicating messages, a term indicating an interface between network objects, terms indicating a variety of identification information are merely examples for the convenience of explanation. Accordingly, the disclosure is not limited to terms described below, and other terms indicating objects having the same technical meanings may be used.

In the following descriptions, a physical channel and a signal may be interchangeably used with data or a control signal. For example, a physical downlink shared channel (PDSCH) refers to a physical channel through which data is transmitted, but the term “PDSCH” may be used to indicate data. That is, in the disclosure, the expression “transmitting a physical channel” may be interpreted or referred to as the same as the expression “transmitting data or a signal through a physical channel.”

In the disclosure, “higher signaling” refers to a signal transmission method by which a base station transmits a signal to a terminal by using a downlink data channel of a physical layer, or a signal transmission method by which a terminal transmits a signal to a base station by using an uplink data channel of a physical layer. The higher signaling may be understood as radio resource control (RRC) signaling or a media access control (MAC) control element (CE).

In the disclosure, terms and names defined in 3rd generation partnership project new radio (3GPP NR) or 3rd generation partnership project long term evolution (3GPP LTE) standards are used for the convenience of explanation. However, the disclosure is not limited by the terms and the names, and may be equally applied to systems conforming to other standards. In the disclosure, gNB may be interchangeably used with eNB for the convenience of explanation. That is, a base station explained as eNB may indicate gNB. In addition, the term “terminal” may indicate not only a mobile phone, a machine type communications (MTC) device, an NB-IoT device, a sensor, but also other wireless communication devices.

A base station, which will be described hereinbelow, refers to an entity that performs resource allocations of a terminal, and may be at least one of a gNodeB (gNB), an eNode B (eNB), a Node B, a base station (BS), a radio access unit, a base station controller, or a node over a network. A terminal may include a user equipment (UE), a mobile station (MS), a cellular phone, a smartphone, a computer, or a multimedia system performing a communication function. Of course, the disclosure is not limited to the above-described examples.

The disclosure may be applied to 3GPP NR (5th generation mobile communication standards). In addition, the disclosure may be applied to intelligent services (for example, a smart home, a smart building, a smart city, a smart car or connected car, health care, digital education, retail business, a security and safety-related service, etc.) which is based on 5G communication technology and IoT-related technology. In the disclosure, eNB may be interchangeably used with Gnb for the convenience of explanation. For example, a base station explained as eNB may indicate gNB. In addition, the term “terminal” may indicate not only a mobile phone, NB-IoT devices, sensors, but also other wireless communication devices.

Beyond the initial function of providing a voice-oriented service, radio communication systems are developing into broadband radio communication systems which provides a packet data service of high-speed, high quality like communication standards, such as high speed packet access (HSPA) of 3GPP, long term evolution (LTE) or evolved universal terrestrial radio access (E-UTRA), LTE-Advanced (LTE-A), LTE-Pro, high rate packet data (HRPD) of 3GPP2, ultra mobile broadband (UWB), and 802.16e of IEEE.

In an LTE system, which is a representative example of the broadband radio communication system, an orthogonal frequency division multiplexing (OFDM) scheme may be employed in downlink (DL), and a single carrier-frequency division multiple access (SC-FDMA) scheme may be employed in uplink (UL). The uplink refers to a wireless link through which a terminal (user equipment (UE) or a mobile station (MS)) transmits data or a control signal to a base station (eNode B or a base station (BS)), and the downlink refers to a wireless link through which a base station transmits data or a control signal to a terminal. In addition, the above-described multiple access schemes may assign or manage time-frequency resources for carrying and transmitting data or control information for each user not to overlap one another, that is, to establish orthogonality, and thereby distinguish data or control information of each user.

According to an embodiment, 5G communication systems which are post-LTE communication systems should support a service satisfying various requirements simultaneously so as to freely reflect various requirements of a user and a service provider. Services which are considered for the 5G communication systems may include enhanced mobile broadband (eMBB), massive machine type communication (mMTC), ultra-reliability low latency communication (URLLC).

According to an embodiment, eMBB aims at providing a high data transmission speed which is more enhanced in comparison to a data transmission speed supported by existing LTE, LTE-A, or LTE-Pro. For example, in 5G communication systems, eMBB may be able to provide a peak data rate of 20 Gbps in downlink and to provide a peak data rate of 10 Gbps in uplink from the point of view of one base station. In addition, the 5G communication systems may provide an increased user perceived data rate of a terminal, while providing the peak data rate. In order to meet the requirements described above, there may be a need for enhancement of various transmission and reception technologies including an enhanced multi input multi output (MIMO) transmission technology in 5G communication systems. In LTE systems, signals are transmitted by using a maximum transmission bandwidth of 20 MHz in a 20 GHz band. On the other hand, in 5G communication systems, a frequency bandwidth larger than 20 MHz is used in a frequency band of 3-6 GHz or 6 GHz or more, so that a data transmission rate required in the 5G communication systems may be satisfied.

At the same time, mMTC is being considered to support an application service such as Internet of thing (IoT) in 5G communication systems. mMTC may require support of access by massive terminals within a cell, enhanced coverage of a terminal, an increased battery time, reduction in a cost of a terminal in order to provide IoT efficiently. Since IoT is attached to various sensors and various devices to provide a communication function, IoT may be able to support many terminals (for example, 1,000,000 terminals/km2) within a cell. In addition, since terminals supporting mMTC are likely to be positioned in a shaded region that is not covered by a cell, such as a basement of a building, due to characteristics of a service, the service of mMTC may require a broader coverage compared to other services provided by 5G communication systems. Since terminals supporting mMTC may be configured with low-priced terminals, and there may be difficulty in replacing a battery of a terminal frequently, there may be a need for a long battery lifetime, for example, a battery life of 10-15 years.

Lastly, URLLC is a cellular-based radio communication service which is used for a specific purpose (mission-critical), and may be used for services used for remote control of a robot or a machinery, industrial automation, an unmanned aerial vehicle, remote health care, and/or an emergency alert. Accordingly, communication provided by URLLC may provide very low latency and very high reliability. For example, services supporting URLLC may satisfy air interface latency shorter than 0.5 millisecond, and simultaneously, may satisfy requirements of a packet error rate of 10-5 or less. Accordingly, 5G systems may provide a shorter transmit time interval (TTI) than other services in order to provide a service supporting URLLC, and simultaneously, may be required to meet design requirements to allocate broad resources in a frequency band in order to guarantee reliability of a communication link.

The three services considered in 5G communication systems, that is, eMBB, URLLC, and/or mMTC, may be multiplexed in one system and may be transmitted. In this case, in order to satisfy different requirements of respective services, different transceiving techniques and transceiving parameters may be used between services. However, the above-described mMTC, URLLC, and/or eMBB are merely different types of services, and a service type to which the disclosure is applicable is not limited to the above-described examples.

In the following descriptions, embodiments of the disclosure will be described by referring to LTE, LTE-A, LTE Pro or 5G (or NR, next-generation mobile communication) systems by way of an example, but embodiments of the disclosure may be applied to other communication systems having similar technical background or channel types. In addition, embodiments of the disclosure may be applied to other communication systems through some modification within the scope without departing from the scope of the disclosure, based on determination of a person skilled in the art.

Embodiments of the disclosure are mainly about a new RAN (NR) which is a radio access network on 5G mobile communication standards, which are specified by 3GPP which is a mobile communication standardization group, and a packet core which is a core network (for example, a 5G system or a 5G core network or a next generation (NG) core). However, the main features of the disclosure are applicable to other communication systems having a similar technical background, and may be modified without departing from the scope of the disclosure. It will be determined by those skilled in the art that the main features of the disclosure are applicable to other communication systems through modification.

In 5G systems, a network data collection and analysis function (NWDAF) which is a network function to provide a function of analyzing and providing collected data in a 5G network may be defined. For example, the NWDAF may collect, store, and/or analyze information from a 5G network and may provide a result to at least one network function (NF), and the analytics result may be independently used in each NF.

In 5G mobile communication systems, NFs are supported to use results of collecting and analyzing network-related data (hereinafter, referred to as network data) through the NWDAF. Supporting NFs to use results of collecting and analyzing network data is to provide collection and analysis of network data that is necessary for respective NFs to provide their functions effectively in a centralized form. The NWDAF may collect and analyze network data by using a network slice as a basic unit. However, the scope of the disclosure is not limited to the network slice unit, and the NWDAF may additionally analyze a state of a user equipment (UE), a PDU session, a network function (NF) and/or a variety of information (for example, service quality) acquired from an external service server.

The result of analyzing through the NWDAF may be delivered to respective NFs which requests the corresponding analytics output, and the delivered analytics output may be used to optimize network management functions such as guaranteeing/enhancing quality of service (QoS), controlling traffic, managing mobility, and/or distributing a load.

A unit node that performs the respective functions provided by 5G network systems may be defined as an NF (or an NF entity or an NF node). For example, each NF may include at least one of an access and mobility management function (AMF) of managing access and mobility of a UE to an access network (AN), a session management function (SMF) of managing a session, a user plane function (UPF) of managing a user data plane, or a network slice selection function (NSSF) of UE's selecting a usable network slice instance.

FIG. 1 illustrates a radio communication network including a network data collection and analysis function (NWDAF) (e.g., development of network data analytics function) according to an embodiment of the present disclosure.

Referring to FIG. 1, the NWDAF (or the NWDAF entity) 105 according to an embodiment may collect network data from at least one source NF in various methods. For example, the at least one source NF from which network data is collected may include NFs within a 5G core network, such as an AMF (or, the AMF entity) 110, a SMF (or the SMF entity) 115, or a UPF (or, the UPF entity) 125, 130 and 135, an application function (AF) (or, the AF entity) for providing an efficient service, a network exposure function (NEF) (or the NEF entity), and/or operation, administration, and maintenance (OAM) (or, the OAM entity).

According to an embodiment, the AMF 110 may connect to a UE 100 and a radio access network (RAN) 120. The UPF 125, 130 and 135 may connect user traffic of the UE 100 passing through the RAN 120 to at least one data network (DN) 140. For example, the UPF 125, 130 and 135 may include an intermediate UPF (I-UPF) 125 and/or a UPF 130 and 135.

According to an embodiment, the NWDAF 105 may provide analysis of network data collected from the network or outside to at least one consumer NF. The NWDAF 105 may collect and analyze a load level of a network slice instance, and may provide the result of collecting and analyzing to a NSSF. For example, the NWDAF 105 may provide the collected and analyzed load level (or load information) to the NSFF, so that the load level is used for a specific UE to select. For example, the NWDAF 105 may select an optimal network slice that can be serviced for a service requested by a specific UE, and may provide an optimal AMF that may support the service requested by the specific UE. For example, the optimal AMF may be referred to as an AMF that supports a service corresponding to highest quality of service (QoS).

According to an embodiment, a service-based interface that is defined in the 5G network may be used for requesting analysis information between the NFs 110, 115 (e.g., AMF 110 and SMF 115) and the NWDAF 105 or for delivering analytics including an analytics output. For example, a hypertext transfer protocol (HTTP) and/or JavaScript object notation (JSON) document may be used as a delivering method.

For example, collection data of the NWDAF 105 may include at least one of an application ID from a point coordination function (PCF), internet protocol (IP) filter information, a media/application bandwidth, a UE identifier from the AMF, location information, a destination data network name (DNN) from the SMF, a UE IP, a QoS flow bit rate, a QoS flow ID (QFI), a QoS flow error rate, a QoS flow delay, or a traffic usage report from the UPF.

According to an embodiment, the NWDAF 105 may additionally collect, from an OAM which is an entity that influences connection between the UE and a service server in addition to the NFs constituting a core network, for example, a NF resource status, a NF throughput, service level agreement (SLA) information, a UE status from the UE, UE application information, a UE usage pattern, an application identifier of a service provided from the AF, a service experience, and/or a traffic pattern, and may utilize the same in analyzing.

[Table 1] to [Table 3] show examples of network data that is collected by the NWDAF 105. That is, the network data collected by the NWDAF 105 may include at least one information element (IE) included in [Table 1] to [Table 3]. A duration during which the NWDAF 105 collects network data from each entity, and a time at which the NWDAF 105 collects network data may be different according to an entity. A correlation of collected data may be identified through a correlation ID for correlating data of respective collection targets, and a timestamp for recording a collection time.

TABLE 1

| Information | Source | Description |
|---|---|---|
| Application | AF | To identify the service and support analytics per |
| ID | | type of service (the desired level of service) |
| IP filter | AF | Identify a service flow of the UE for the |
| information | | application |
| Locations | AF/ | Locations of application represented by a list of |
| of | NEF | DNAI(s). The NEF may map the AF-Service- |
| Application | | Identifier information to a list of DNAI(s) when |
| | | the DNAI(s) being used by the application are |
| | | statically defined. |
| Service | AF | Refers to the QoE per service flow as |
| Experience | | established in the SLA and during on boarding. |
| | | It can be either e.g., MOS or video MOS as |
| | | specified in ITU-T P.1203.3 or a customized |
| | | MOS |
| Timestamp | AF | A time stamp associated to the Service |
| | | Experience provided by the AF, mandatory if |
| | | the Service Experience is provided by the ASP. |

TABLE 2

| Information | Source | Description |
|---|---|---|
| Timestamp | 5GC | A time stamp associated with the collected |
| | NF | information. |
| Location | AMF | The UE location information. |
| SUPI(s) | AMF | If UE IDs are not provided as target of |
| | | analytics reporting for slice service |
| | | experience, AMF returns the UE IDs |
| | | matching the AMF event filters. |
| DNN | SMF | DNN for the PDU Session which contains |
| | | the QoS flow |
| S-NSSAI | SMF | S-NSSAI for the PDU Session which |
| | | contains the QoS flow |
| Application | SMF | Used by NWDAF to identify the application |
| ID | | service provider and application for the QoS |
| | | flow |
| IP filter | SMF | Provided by the SMF, which is used by |
| information | | NWDAF to identify the service data flow for |
| | | policy control and/or differentiated charging |
| | | for the QoS flow |
| QFI | SMF | QoS Flow Identifier |
| QoS flow Bit | UPF | The observed bit rate for UL direction; and |
| Rate | | the observed bit rate for DL direction |
| Qos flow | UPF | The observed Packet delay for UL direction; |
| Packet Delay | | and the observed Packet delay for the DL |
| | | direction |
| Packet | UPF | The observed number of packet transmission |
| transmission | | |
| Packet | UPF | The observed number of packet |
| retransmission | | retransmission |

TABLE 3

| Information | Source | Description |
|---|---|---|
| Timestamp | OAM | A time stamp associated with the collected |
| | | information. |
| Reference | OAM | The per UE measurement of the received power |
| Signal Received Power | | level in a network cell, including SS-RSRP, CSI-RSRP |
| | | as specified in TS 38.331 and E-UTRA RSRP as |
| | | specified in TS 36.331 |
| Reference | OAM | The per UE measurement of the received |
| Signal Received | | quality in a network cell, including SS-RSRQ, CSI- |
| Quality | | RSRQ as specified in TS 38.331 and E-UTRA RSRQ as |
| | | specified in TS 36.331 |
| Signal-to- | OAM | The per UE measurement of the received signal |
| noise and interference | | to noise and interference ratio in a network cell, |
| ratio | | including SS-SINR, CSI-SINR, E-UTRA RS-SINR, as |
| | | specified in TS 38.215 |

The function of the disclosure may be referred to as a virtualized network function. For example, the function of the disclosure may be referred to as a network function that is virtualized by network function virtualization (NFV). Accordingly, an operation or a step that is performed by the network function of the disclosure may be understood as an operation or a step that is performed by a server supporting a network (or a core network). For example, an operation or a step (for example, operations or steps illustrated in FIGS. 1 to 4) that is performed by the network function (for example, a NRF entity, a first NWDAF entity, a second NWDAF entity, an ARDF entity, a MDAF entity) of the disclosure may be understood as an operation or a step that is performed by at least one processor of a server supporting a network.

Although, through FIG. 1 to FIG. 7 of the disclosure, a network entity for collecting management information is described as a second NWDAF entity, the network entity for collecting the management information is not limited to the second NWDAF entity. For example, the network entity for collecting the management information is named with different names.

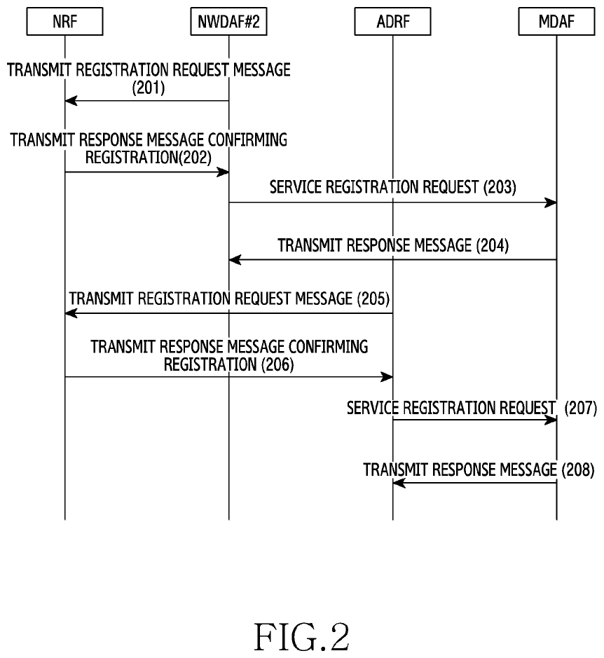

FIG. 2 illustrates a signal flowchart of an operation in which a network function of a control plane supporting an interface with a network function of a management plane registers a function at a network function repository function (NRF) according to an embodiment of the present disclosure. A step illustrated in the disclosure may be substituted with an operation. Explanation of the NWDAF 105 in FIG. 1 may be applied to the NWDAF illustrated in the disclosure.

Referring to FIG. 2, at step 201, the NWDAF according to an embodiment may transmit a registration request message (or, information) for registering a type of a service and a function that the NWDAF itself provides at the NRF (e.g., Nnrf_NFRegistration request).

For example, the registration request message may include information indicating that the network function type is a network data analysis function (e.g., NF Type=NWDAF), an NWDAF identification (ID), an OMA data collection capability parameter indicating whether it is possible to support collection of data of the management plane, a service area that is geographical area information for providing a data collection and analysis service of the NWDAF, a location of the NWDAF, authentication information including a list of network functions that are allowed to use a management plane data collection function provided by the NWDAF, and/or information on a validity time indicating until when a service can be provided (e.g., a validity time indicating a duration during which a service can be provided). However, the information included in the above-described registration request message is merely an example. Accordingly, the registration request message may further include additional information beside the above-described information.

According to an embodiment, at step 201, instead of registering authentication information at the NRF by the NWDAF, an operator, etc. may separately configure information of network functions that are allowed to use the management plane data collection function of the NWDAF, directly at the NRF offline, after information registration of the NWDAF is completed.

According to an embodiment, at step 202, the NRF may transmit a response message confirming that the information is registered to the NWDAF (e.g., Nnrf_NFRegistration Response).

According to an embodiment, at step 203, the NWDAF may request a management data analytics function (MDAF) to register a service (e.g., service registration request). For example, the NWDAF may transmit information on a service and a function that the NWDAF itself provides to the MDAF of the management plane that supports a signal interface with the NWDAF (e.g., service registration request). For example, instead of directly delivering information to the MDAF, the NWDAF may request information registration by transmitting a message to a registration management function designated on the management plane. For example, the message may include a NWDAF identifier (ID), a NWDAF analytics exposure capability parameter indicating whether the MDAF can support a function of providing a result of analyzing by the NWDAF on the control plane, and/or information on types of analysis that are provided. The message may further include information on a service area and a location of the NWDAF, and/or a validity time indicating until when the service can be provided, in addition to the NWDAF analytics exposure capability parameter and information on the types of analysis that are provided.

According to an embodiment, at step 204, the MDAF may transmit a response message to the request message of step 203 to the NWDAF (e.g., service registration response).

According to an embodiment, at step 205, an analytics data repository function (ADRF) may transmit, to the NRF, a registration request message for registering a type and a function of a service that the ADRF provides (e.g., Nnrf_NFRegistration Request). For example, the registration request message may include information indicating that the network function type is an analytics data storage function (e.g., NF type=ADRF), an ADRF ID, an OAM data collection capability parameter indicating whether collection of data of the management plane (or, management data) can be supported, a service area which is geographical area information for providing a data collection and analysis service of the ADRF, a location of the ADRF, authentication information including a list of network functions that are allowed to use the management plane data collection function provided by the ADRF, and/or information on a validity time indicating until when the service can be provided. At step 205, instead of registering authentication information at the NRF by the ADRF, an operator, etc. may separately configure information of network functions that are allowed to use the management plane data collection function of the ADRF, directly at the NRF offline, after information registration of the ADRF is completed.

According to an embodiment, at step 206, the NRF may transmit a response message confirming that the information is registered to the ADRF (e.g., Nnrf_NFRegistration Response).

According to an embodiment, at step 207, the ADRF may request service registration. For example, the ADRF may transmit information on a service and a function that the ADRF itself provides to the MDAF of the management plane that supports a signal interface with the ADRF (e.g., service registration request).

For example, instead of directly delivering information to the MDAF, the ADRF may request information registration by transmitting a message to a registration management function designated on the management plane. For example, the message may include an ADRF ID, a NWDAF analytics exposure capability parameter indicating whether the MDAF can support a function of providing a result of analyzing by the NWDAF on the control plane, and/or information on types of analysis that are provided. The message may further include information on a service area and a location of the ADRF, and/or a validity time indicating until when the service can be provided, in addition to the NWDAF analytics exposure capability parameter and information on the types of analysis that are provided.

According to an embodiment, at step 208, the MDAF may transmit a response message to the request message of step 203 to the ADRF or the message for the request service registration of step 207.

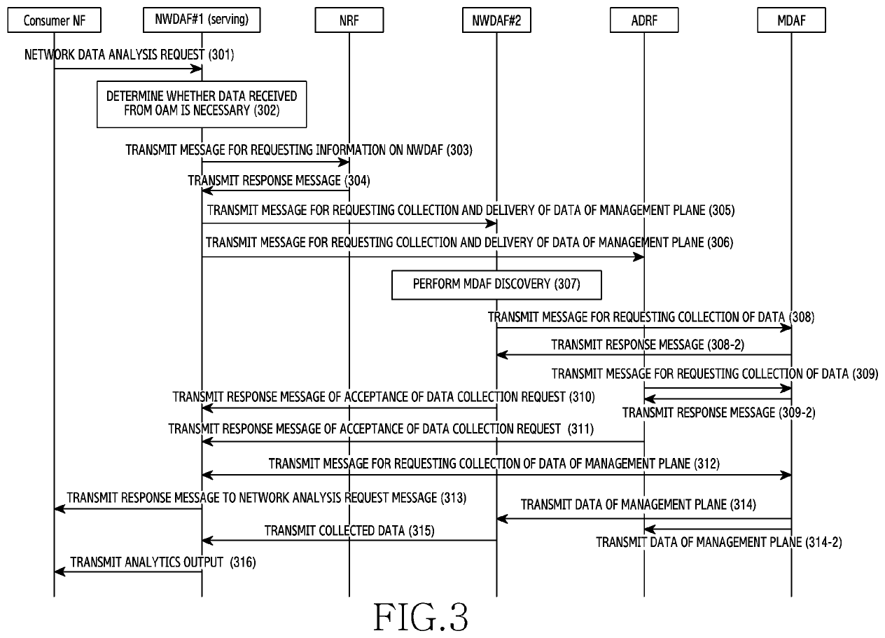

FIG. 3 illustrates a signal flowchart of an operation in which a network data analysis function receives a request for network data analysis from a consumer network function, collects data of a management plane, and delivers (or, transmits) an analytics output to the consumer network function according to an embodiment of the present disclosure.

Referring to FIG. 3, at step 301 according to an embodiment, the consumer network function (consumer NF) may request a first NWDAF (NWDAF #1) that is usable at a position thereof to analyze necessary network data (e.g., Nnwdaf_AnalyticsExposure_Subscribe request). For example, a request message may include an identification of UE (UE ID) that is a target for requesting, and/or analytics ID information designating a type of analysis to be requested.

At step 302, the first NWDAF (NWDAF #1) which receives the analysis request from the consumer network function (consumer NF) may determine or identify a type of network data that is designated or indicated by the consumer network function through the analytics ID and is necessary for calculating an analytics output. In addition, at step 302, the first NWDAF (NWDAF #1) may determine whether data collected by management functions which are in charge of an OAM function on the management plane is necessary for calculating an analytics output (e.g., data from OAM is required). For example, the first NWDAF (NWDAF #1) may determine whether data (or, management data) collected from the OAM is necessary.

According to an embodiment, at step 303, the first NWDAF (NWDAF #1) may transmit, to a NRF, a message for requesting information on a candidate NWDAF that supports a signal interface with the management plane in order to receive data from the managing plane (Nnrf_NFDiscovery_Request). For example, the message may include an NF type parameter (e.g., NF Type=NWDAF) designating or indicating that a network function to discover (or to search) is the NWDAF (or ADRF or NWDAR and ADRF), an analytic ID that requires data collection, a service area indicating a service area that requires data collection, and/or an OAM data support parameter indicating that the network function to discover may be a network function supporting a management plane data collection function. In case that the NWDAF itself supports a signal interface with the management plane in order to receive data from the management plane, the NWDAF may directly transmit, to a MDAF of the management plane, a message for requesting to collect data of the management plane and to deliver by using the signal interface. In case that the NWDAF directly transmits the message to the MDAF of the management plane, step 303 and step 304 may be omitted.

According to an embodiment, at step 304, the NRF may add, to a response message, identification information (e.g., a NF ID, a NF profile) of candidate NWDAFs (or ADRFs or NWDAR and ADRFs) that are suitable for a condition requested by the NWDAF at step 303 and support collection of data of the management plane, and may transmit the response message to the NWDAF (Nnrf_NFDiscovery_Response). At step 304, the NRF may identify or determine whether the first NWDAF (NWDAF #1) transmitting the message for requesting information on NWDAFs is a network function that is allowed to collect management plane data through each NWDAF (or ADRF) included in the response message, based on authentication information stored in the NRF.

According to an embodiment, when the NWDAF (NWDAF #1) is a network function that is not allowed to collect management plane data, the NRF may inform that there is no allowable NWDAF (or ADRF), or no allowable NWDAF (or ADRF) exists by adding an indicator informing that the request is refused to the response message or by not adding NWDAF (or ADRF) information. The NRF may add, to the response message, only the information on the NWDAFs (or ADRF or NWDAR and ADRF) that are allowed to be used by the first NWDAF (NWDAF #1) having requested at step 303 to collect management plane data, and may transmit the response message to the first NWDAF (NWDAF #1).

According to an embodiment, at step 305, the first NWDAF (NWDAF #1) may select a second NWDAF (NWDAF #2) based on the information on the NWDAFs that is received from the NRF and is usable in collecting data of the management plane, and may transmit a message for requesting to collect and deliver data of the management data (Nnwdaf_AnalyticsExposure_Subscribe). For example, the message may include a UE ID for designating a target for collecting data, an analytics ID, an OAM data collection parameter for indicating collection of data of the management plane, a report period for reporting collected data, and/or information on a data variation range threshold for determining whether to report. For example, the first NWDAF (NWDAF #1) may transmit request information for analyzing network data, which is received from the consumer NF at step 301, to the second NWDAF (NWDAF #2), and may request the second NWDAF to process the analysis requested by the consumer NF. In this case, step 313 and step 316 may be directly performed by the second NWDAF.

According to an embodiment, at step 306, the first NWDAF (NWDAF #1) may select or identify an ADRF based on the information on the NWDAFs that is received from the NRF and is usable in collecting data of the management plane, and the first NWDAF (NWDAF #1) may transmit a message for requesting to collect and deliver data of the management plane (Nndrf_EventExposure_Subscribe). For example, the message may include a UE ID for designating a target for collecting data, an analytics ID, an OAM data collection parameter for indicating collection of data of the management plane, a report period for reporting collected data, and/or a data variation range threshold for determining whether to report.

According to an embodiment, at step 307, the second NWDAF (NWDAF #2) or the ADFR which receives the request for collecting and delivering data of the management plane may perform a MDAF discovery procedure for discovering a management data analytics function of the management plane.

According to an embodiment, at step 308, the second NWDAF (NWDAF #2) may transmit a message for requesting collection of data of the management plane to the MDAF that is selected through the process of step 307 (data request). For example, the message may include an ID of UE that is designated as a target for collecting data, a list of data to be collected (data list), and/or a report period, and information on a data variation range threshold for determining whether to report, based on the information received from the first NWDAF (NWDAF #1) having requested data collection. In another example, the message may include information for designating a geographical area (for example, a base station ID, a CELL ID, a TRACKING AREA ID, latitude and altitude) where data is to be collected, or a time. At step 308, the second NWDAF (NWDAF #2) may change, convert, or reconfigure a parameter that is included in the signal message of the control plane received from the first NWDAF (NWDAF #1) having requested data collection to, into, as a parameter suitable for a format of a signal message of the management plane, and may newly configure a signal message of the management plane. That is, the second NWDAF (NWDAF #2) may interpret or identify a signal protocol that is used on the control plane (or management plane), and translate into a signal protocol that is used on the management plane (or control plane), and may perform a function of relaying.

According to an embodiment, at step 308-2, the MDAF may transmit a response message to the second NWDAF (NWDAF #2). For example, the MDAF may transmit the response message to the second NWDAF (NWDAF #2) in response to transmission of the message for requesting data collection.

According to an embodiment, at step 309, the ADRF may transmit a message for requesting collection of data of the management plane to the MDAF that is selected through the process of step 307 (data request). For example, the message may include an ID of UE that is designated as a target for collecting data, a list of data to be collected (data list), a report period, and/or information on a data variation range threshold for determining whether to report, based on the information received from the first NWDAF (NWDAF #1) having requested data collection. In another example, the message may include information for designating a geographical area (for example, a base station ID, a CELL ID, a TRACKING AREA ID, latitude, and altitude) where data is to be collected, or a time. At step 309, the ADRF may change, convert, or reconfigure a parameter that is included in the signal message of the control plane received from the first NWDAF (NWDAF #1) having requested data collection to, into, as a parameter corresponding to a format of a signal message of the management plane, and may newly configure a signal message of the management plane. That is, the NWDAF may interpret or identify a signal protocol that is used on the control plane (or management plane), and translate into a signal protocol that is used on the management plane (or control plane), and may perform a function of relaying.

According to an embodiment, at step 309-2, the MDAF may transmit a response message to the ADRF. For example, the MDAF may transmit the response message to the ADRF in response to transmission of the message for requesting data collection.

According to an embodiment, at step 310, the second NWDAF (NWDAF #2) may transmit, to the first NWDAF (NWDAF #1) having requested collection of data of the management plane, a response message notifying that the data collection request is accepted (Nnwdaf_AnalyticsExposure_Notify). For example, the message may include an identifier of UE (UE ID) that is allowed to collect and an analytics ID related to the collected data, and may include report period information (e.g., a report period) of the collected data that is received from the MDAF and supported by the MDAF. In addition, the message may include an identification of the MDAF (e.g., an MDAF ID) that is in charge of collection of management plane data, and/or an address to which a signal message is directly delivered (e.g., a report address) in order to enable direct communication when the NWDAF having requested collection of the management plane data supports an interface with the MDAF.

According to an embodiment, at step 311, the ADRF may transmit a response message notifying or indicating that the data collection request is accepted to the first NWDAF (NWDAF #1) having requested collection of data of the management plane (Nadrf_EventExposure_Notify). For example, the message may include an identification of UE (UE ID) that is allowed to collect data, an analytics ID related to the collected data, and/or report period information of the collected data that is received from the MDAF and supported by the MDAF.

According to an embodiment, at step 312, in case that the first NWDAF (NWDAF #1) supports direct communication with the MDAF, the first NWDAF (NWDAF #1) may transmit a message for requesting collection of data of the management plane to the MDAF by using MDAF information received at step 310 (data request). For example, the message may include an identification of UE (UE ID) that is a target for collecting data and a list of data to be collected, a report period for reporting collected data, and/or information on a data variation range threshold for determining whether to report.

According to an embodiment, at step 313, the first NWDAF (NWDAF #1) may transmit a response message to the network analysis request message that is transmitted by the consumer NF (Nnwdaf_AnalyticsExposure_Subscribe_Response). For example, the message may include an analytics ID indicating a type of analysis the analysis request of which is accepted, and/or report period information which is corrected for analysis of data of the management plane by the MDAF.

According to an embodiment, at step 314 or step 314-2, the MDAF may transmit data of the management plane that is collected for the requested collection target to the second NWDAF (NWDAF #2) or the ADRF supporting an interface with the management data plane (data request). For example, at step 314, the MDAF may transmit data of the management plane to the second NWDAF (NWDAF #2). For example, at step 314-2, the MDAF may transmit data of the management plane to the ADRF (when the NWDAF #1 directly transmits a request message at the previous step, data may be directly transmitted to the NWDAF #1). For example, the data of the management plane may include an identification of UE (UE ID) which is a target for collecting data, and/or collected data.

According to an embodiment, at step 315, the second NWDAF (NWDAF #2) or the ADRF which receives the management data collected from the MDAF at step 314 may determine or identity parameters to be included in a signal message of the control plane, based on parameters included in the signal message of the management plane received. The second NWDAF (NWDAF #2) or the ADRF may configure a signal message of the control plane and may transmit the collected data to the first NWDAF (NWDAF #1) which has requested collection of the management plane data (Nnwdaf_AnalyticsExposure_Notify). In another example, the second NWDAF (NWDAF #2) may calculate an intermediate analytics output from the collected data received from the MDAF, and may transmit the calculated analytics output to the first NWDAF (NWDAF #1) which has requested data collection and an analytics output. For example, the collected data may include an identification of UE (e.g., a UE ID), an analytics ID indicating a type of analysis the analysis request of which is accepted, and/or collected data.

According to an embodiment, at step 316, the first NWDAF (NWDAF #1) may synthesize all of the data collected from the network which includes data collected from the management plane, and may calculate a final analytics output to be delivered to the consumer NF. The first NWDAF (NWDAF #1) may transmit the analytics output to the consumer NF (Nnwdaf_AnalyticsExposure_Notify).

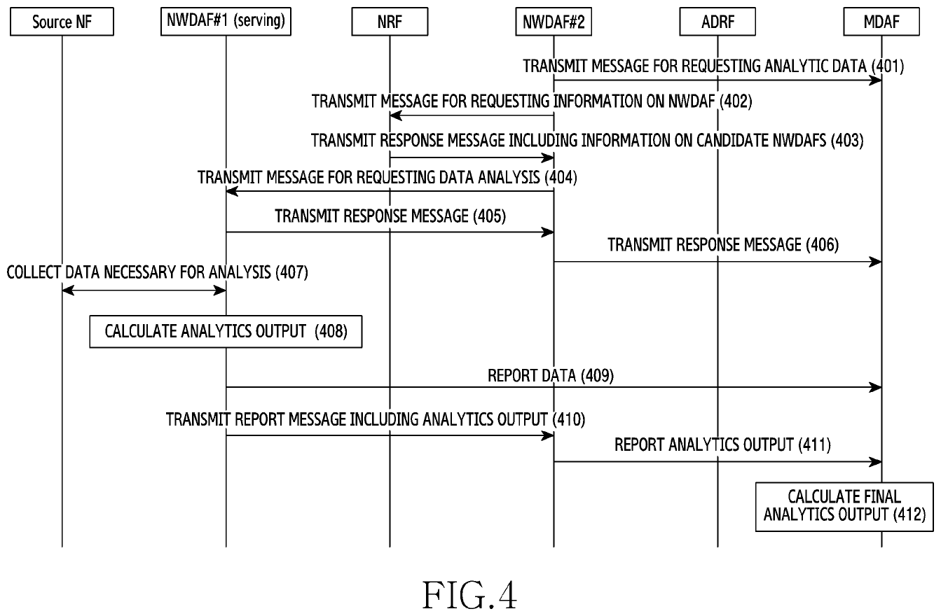

FIG. 4 illustrates a signal flowchart of an operation in which a data analysis function of a management plane generates an analytics output to be used on the management plane according to an embodiment of the present disclosure.

FIG. 4 illustrates a signal flowchart of an operation (or step) in which the data analysis function of the management plane requests a network data analysis function of a control plane to collect network data on the control plane or to analyze the network data, and an operation in which the data analysis function of the management plane receives collected data and an analytics output, and generates an analytics output to be used on the management plane, based on the collected data and the analytics output.

Referring to FIG. 4, at step 401 according to an embodiment of the disclosure, the MDAF may transmit a message for requesting analysis data generated on the control plane to the second NWDAF (NWDAF #2) which supports an interface with the management plane (e.g., data request). For example, the message may include an identification of UE which is an analysis target (e.g., a UE ID) or a network function identification, an item of data for which analysis is requested, a report period, and/or a data variation range threshold for determining whether to report.

According to an embodiment, at step 402, the second NWDAF (NWDAF #2) may interpret or identify the request message transmitted by the MDAF and may determine a type of analysis required and a service area, and may transmit a message for requesting information on an NWDAF that satisfies a designated condition to the NRF in order to determine or identify an appropriate NWDAF that satisfies the designated condition (e.g., a condition where a specified type of analysis is processed and which corresponds to the service area) and is in charge of required analysis (Nnrf_NFDiscovery_Request). For example, the message may include an NF TYPE for designating a NWDAF, an analytics ID requiring analysis, a service area in which data is collected and analyzed, and/or an OAM data support parameter indicating requirements regarding direct communication with the management plane.

According to an embodiment, at step 403, the NRF may add information on candidate NWDAFs that satisfy the condition requested by the NWDAF (e.g., an NF ID and/or an NF profile) to a response message, and may transmit the response message to the NWDAF (Nnrf_NFDiscovery_Reponse).

According to an embodiment, at step 404, the second NWDAF (NWDAF #2) may select one of the candidate NWDAFs received from the NRF at step 403, and may transmit a message for requesting data analysis to the selected NWDAF (Nnwdaf_AnalyticsExposure_Subscribe). For example, the message may include a UE identification (UE ID) or a network function identification which is a target to be analyzed based on the request received from the MDAF, an analytics ID designating a type of analysis required, a consumer ID, a report period which is used when an analytics output is directly delivered to the MDAF, and/or report address information. For example, the consumer ID may correspond to an identification for specifying that the consumer network function is a management data analysis function of the management plane in order for the first NWDAF (NWDAF #1), which has received the response, to determine whether to directly deliver an analytics output to the MDAF.

According to an embodiment, at step 405, the first NWDAF (NWDAF #1) may determine whether to directly deliver an analytics output to the MDAF, based on whether the first NWDAF supports an interface with the management plane and/or operator's configuration, and may add information regarding direct transmission in a response message and may transmit the response message to the second NWDAF (NWDAF #2) (Nnwdaf_AnalyticsExposure_Notify) (e.g., direct report).

According to an embodiment, at step 406, the second NWDAF (NWDAF #2) may transmit a response message corresponding to the request of step 401 to the MDAF (data report (NWDAF ID)). For example, the message may include information (e.g., a NWDAF ID) on a NWDAF to which the analytics output is transmitted. In case that the second NWDAF (NWDAF #2) itself directly transmits the analytics output to the MDAF, step 406 may be omitted.

According to an embodiment, at step 407, the first NWDAF (NWDAF #1) which is in charge of analysis may collect data necessary for analyzing on the control plane from each network function (Nnf_EventExposure_Subscribe). For example, the collected data may include a UE ID and/or an event ID. For example, a source NF may transmit data necessary for analysis to the first NWDAF (NWDAF #1).

According to an embodiment, at step 408, the NWDAF may analyze the collected data and may calculate an analytics output (analytics generation).

According to an embodiment, at step 409, when the NWDAF determines to directly transmit the analytics output to the MDAF at step 405, the NWDAF may convert the analytics output into a data format and parameters to be used on the management plane, or reconfigure the analytics output, based on the analyzed result (or by synthesizing the analyzed result). The NWDAF may configure a signal message of the management plane and may transmit the analytics output to the MADF (data report). For example, the NWDAF may transmit the UE ID and/or the analytics output to the MDAF at step 405.

For example, a parameter that is utilized or used for the calculated analytics output and a parameter that is utilized on the management plane may not be mapped, and may require data conversion. Accordingly, when the NWDAF determines to directly transmit the analytics output to the MDAF, the NWDAF may convert the analytics output into a data format and parameters to be used on the management plane.

According to an embodiment, at step 410, in case that the NWDAF determines not to directly transmit the analytics output to the MDAF at step 405, the NWDAF may transmit a report message including the analytics to the second NWDAF (NWDAF #2) which requests analysis on behalf of the MDAF (Nnwdaf_AnalyticsExposure_Notify). For example, the message may include a UE ID, an analytic ID, a consumer ID for designating the MDAF to indicate that the analytics output calculated on the control plane may be transmitted to the management plane, and/or reporting address information.

According to an embodiment, at step 411, the second NWDAF (NWDAF #2) which receives the analytics output may synthesize the received output, and may convert the received output into a data analysis parameter to be applied to the management plane and may configure a signal message of the management plane, and may transmit the signal message of the management plane to the MDAF (data report). For example, the second NWDAF (NWDAF #2) may transmit the UE ID and/or the analytics output to the MDAF.

According to an embodiment, at step 412, the MDAF may calculate a final analytics output that is required to efficiently control the management function on the management plane, based on the analytics output of the control plane (analytics generation for management plane). The MDAF may transmit the result of calculating to the consumer function of the management plane and control to optimize operations of the consumer function. For example, the MDAF may transmit the result of calculating to the consumer function of the management plane to provide maximum quality of experience (QoE).

A method performed by a first network data collection and analysis function (NWDAF) entity in a mobile communication system is provided. The method comprises transmitting, to a network entity for collecting management information, a first request message for collection of first management information for a network function (NF) entity, receiving, from the network entity, the first management information for the NF entity and identifying a result of an analysis for the NF entity based on the first management information for the NF entity.

The method further comprises receiving, from the network entity, a first message as a response of the first request message. The first message includes at least one of a user equipment (UE) identifier (ID) for the collection of the first management information, an analytic ID for the analysis, or a report period for the first management information.

The method further comprises transmitting, to the network entity, a second request message for an intermediate analysis for the NF entity and receiving, from the network entity, the intermediate analysis for the NF entity as a response of the second request message.

The method further comprises identifying a type of the first management information for the result of the analysis.

The NF entity corresponds to an access and mobility management function (AMF) entity, a session management function (SMF) entity, or a user plane function (UPF) entity. The network entity for collecting the management information corresponds to a second NWDAF entity different from the first NWDAF entity.

A first network data collection and analysis function (NWDAF) entity in a mobile communication system is provided. The first NWDAF entity comprises a transceiver and a controller coupled with the transceiver and configured to transmit, to a network entity for collecting management information, a first request message for collection of first management information for a network function (NF) entity, receive, from the network entity, the first management information for the NF entity and identify a result of an analysis for the NF entity based on the first management information for the NF entity.

The controller is further configured to receive, from the network entity, a first message as a response of the first request message. The first message includes at least one of a user equipment (UE) identifier (ID) for the collection of the first management information, an analytic ID for the analysis, or a report period for the first management information.

The controller is further configured to transmit, to the network entity, a second request message for an intermediate analysis for the NF entity and receive, from the network entity, the intermediate analysis for the NF entity as a response of the second request message.

The controller is further configured to identify a type of the first management information for the result of the analysis.

The NF entity corresponds to an access and mobility management function (AMF) entity, a session management function (SMF) entity, or a user plane function (UPF) entity, and the network entity for collecting the management information corresponds to a second NWDAF entity different from the first NWDAF entity.

A method performed by a network entity for collecting management information in a mobile communication system is provided. The method comprises receiving, from a first network data collection and analysis function (NWDAF) entity, a first request message for collecting first management information for a network function (NF) entity and transmitting, to the first NWDAF entity, the first management information for the NF entity. A result of an analysis for the NF entity is based on the first management information for the NF entity.

The method further comprises transmitting, to first NWDAF entity, a first message as a response of the first request message. The first message includes at least one of a user equipment (UE) identifier (ID) for collecting the first management information, an analytic ID for the analysis or a report period for the first management information.

The method further comprises receiving, from the first NWDAF entity, a second request message for an intermediate analysis for the NF entity and performing the intermediate analysis for the NF entity.

The method further comprises transmitting, to the first NWDAF entity, the intermediate analysis for the NF entity as a response of the second request message. The result of the analysis for the NF entity is based on the first management information and the intermediate analysis.

The NF entity corresponds to an access and mobility management function (AMF) entity, a session management function (SMF) entity, or a user plane function (UPF) entity, and the network entity for collecting management information corresponds to a second NWDAF entity different from the first NWDAF entity.

A network entity for collecting management information in a mobile communication system is provided. The network entity comprises a transceiver; and a controller coupled with the transceiver and configured to receive, from a first network data collection and analysis function (NWDAF) entity, a first request message for collecting first management information for a network function (NF) entity, and transmit, to the first NWDAF entity, the first management information for the NF entity. A result of an analysis for the NF entity is based on the first management information for the NF entity.

The controller is further configured to transmit, to first NWDAF entity, a first message as a response of the first request message. The first message includes at least one of a user equipment (UE) identifier (ID) for collecting the first management information, an analytic ID for the analysis or a report period for the first management information.

The controller is further configured to receive, from the first NWDAF entity, a second request message for an intermediate analysis for the NF entity and perform the intermediate analysis for the NF entity.

The controller is further configured to transmit, to the first NWDAF entity, the intermediate analysis for the NF entity as a response of the second request message. The result of the analysis for the NF entity is based on the first management information and the intermediate analysis.

The NF entity corresponds to an access and mobility management function (AMF) entity, a session management function (SMF) entity, or a user plane function (UPF) entity, and the network entity for collecting management information corresponds to a second NWDAF entity different from the first NWDAF entity.

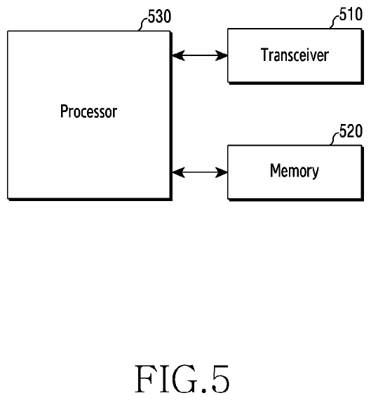

FIG. 5 illustrates a structure of a base station according to an embodiment of the present disclosure.

As shown in FIG. 5, the base station according to an embodiment may include a transceiver 510, a memory 520, and/or a processor 530. The transceiver 510, the memory 520, and the processor 530 of the base station may operate according to a communication method of the base station described above. However, the components of the base station are not limited thereto. For example, the base station may include more or fewer components than those described above. In addition, the processor 530, the transceiver 510, and the memory 520 may be implemented as a single chip. Also, the processor 530 may include at least one processor. The base station of FIG. 5 may correspond to the RAN 120 of FIG. 1.

The transceiver 510 collectively refers to a base station receiver and a base station transmitter, and may transmit/receive a signal to/from a terminal (UE) or a network entity. The signal transmitted or received to or from the terminal or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the base station. Also, the memory 520 may store control information or data included in a signal obtained by the base station. The memory 520 may be a storage medium, such as read-only memory (ROM), random access memory (RAM), a hard disk, a CD-ROM, and a DVD, or a combination of storage media.

The processor 530 may control a series of processes such that the base station operates as described above. For example, the transceiver 510 may receive a data signal including a control signal transmitted by the terminal, and the processor 530 may determine a result of receiving the control signal and the data signal transmitted by the terminal.

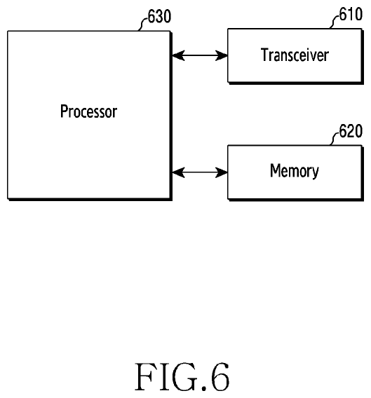

FIG. 6 illustrates a structure of a UE according to an embodiment of the present disclosure.

As shown in FIG. 6, the UE according to an embodiment may include a transceiver 610, a memory 620, and/or a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor. Furthermore, the UE of FIG. 6 corresponds to the UE 100 of the FIG. 1.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

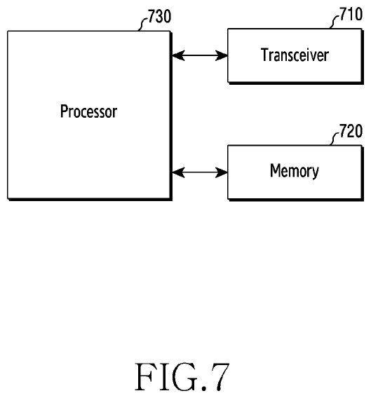

FIG. 7 illustrates a structure of a network entity according to an embodiment of the present disclosure.

As shown in FIG. 7, the network entity of the present disclosure may include a transceiver 710, a memory 720, and/or a processor 730. The transceiver 710, the memory 720, and the processor 730 of the network entity may operate according to a communication method of the network entity described above. However, the components of the terminal are not limited thereto. For example, the network entity may include more or fewer components than those described above. In addition, the processor 730, the transceiver 710, and the memory 720 may be implemented as a single chip. Also, the processor 730 may include at least one processor.

For example, the network entity of FIG. 7 corresponds to the AMF entity, the MME entity, the first NWDAF entity, the second NWDAF entity, ADRF entity, NRF entity, NF entity and/or MDAF entity of the FIG. 1 to FIG. 7.

The transceiver 710 collectively refers to a network entity receiver and a network entity transmitter, and may transmit/receive a signal to/from a base station or a UE. The signal transmitted or received to or from the base station or the UE may include control information and data. In this regard, the transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the network entity. Also, the memory 720 may store control information or data included in a signal obtained by the network entity. The memory 720 may be a storage medium, such as ROM, RAM, a hard disk, a CD-ROM, and a DVD, or a combination of storage media.

The processor 730 may control a series of processes such that the network entity operates as described above. For example, the transceiver 710 may receive a data signal including a control signal, and the processor 730 may determine a result of receiving the data signal.

A method performed by a network entity in a radio communication system according to an embodiment of the disclosure may include transmitting information for registering a network function supported by the network entity at a network function repository function (NRF), and transmitting the information for registering the network function supported by the network entity to a management data analytics function (MDAF).

The method performed by the network entity in the radio communication system according to an embodiment may include collecting a variety of data of A network and a step of analyzing the collected data.

The method performed by the network entity in the radio communication system according to an embodiment may include requesting collection of data from a management plane for data analysis, and receiving the collected data.

The method performed by the network entity in the radio communication system according to an embodiment may include delivering information for controlling to operate the network efficiently based on a result of analyzing the collected data.

The disclosure provides an apparatus and a method for providing a service effectively in a radio communication system.

The effect achieved by the disclosure is not limited to those mentioned above, and other effects that are not mentioned above may be clearly understood to those skilled in the art based on the description provided above.

Embodiments of the disclosure disclosed in the specification and the drawings provide specific examples for easy explanation of the technical features of the disclosure and for easy understanding of the disclosure, and do not limit the scope of the disclosure. That is, it is obvious to a person skilled in the art that other variations based on the technical concept of the disclosure are possible. In addition, the above-described embodiments may be operated in combination when necessary. For example, at least part of the embodiments of the disclosure may be operated by a base station or a terminal in combination.

In the above-described specific embodiments of the disclosure, elements included in the disclosure are expressed in singular or plural forms according to specific embodiments. However, singular or plural forms are appropriately selected according to suggested situations for convenience of explanation, and the disclosure is not limited to a single element or plural elements. An element which is expressed in a plural form may be configured in a singular form or an element which is expressed in a singular form may be configured in plural number.

Embodiments of the disclosure disclosed in the specification and the drawings provide specific examples for easy explanation of the technical features of the disclosure and for easy understanding of the disclosure, and do not limit the scope of the disclosure. In addition, the embodiments of the disclosure described above are merely examples, and it will be understood by those skilled in the art that various modifications therefrom and embodiments in the equivalent range are possible. Accordingly, the technical protection scope of the disclosure should be defined based on the claims presented below.

A method performed by a network entity in a radio communication system according to an embodiment of the disclosure may include transmitting information for registering a network function supported by the network entity at a network function repository function (NRF), and transmitting the information for registering the network function supported by the network entity to a management data analytics function (MDAF).

A method performed by a network entity to collect data of a management plane in a radio communication system according to an embodiment of the disclosure may be implemented by a new network entity besides an NWDAF and an ADRF.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first network data collection and analysis function (NWDAF) entity in a mobile communication system, the method comprising:
transmitting, to a network entity for collecting management information, a first request message for collection of first management information for a network function (NF) entity;
receiving, from the network entity, the first management information for the NF entity; and
identifying a result of an analysis for the NF entity based on the first management information for the NF entity.

2. The method of claim 1, further comprising:
receiving, from the network entity, a first message as a response of the first request message,
wherein the first message includes at least one of a user equipment (UE) identifier (ID) for the collection of the first management information, an analytic ID for the analysis, or a report period for the first management information.

3. The method of claim 1, further comprising:
transmitting, to the network entity, a second request message for an intermediate analysis for the NF entity; and
receiving, from the network entity, the intermediate analysis for the NF entity as a response of the second request message.

4. The method of claim 1, further comprising:
identifying a type of the first management information for the result of the analysis.

5. The method of claim 1, wherein the NF entity corresponds to an access and mobility management function (AMF) entity, a session management function (SMF) entity, or a user plane function (UPF) entity, and
wherein the network entity for collecting the management information corresponds to a second NWDAF entity different from the first NWDAF entity.

6. A first network data collection and analysis function (NWDAF) entity in a mobile communication system, the first NWDAF entity comprising:
a transceiver; and
a controller coupled with the transceiver and configured to:
transmit, to a network entity for collecting management information, a first request message for collection of first management information for a network function (NF) entity,
receive, from the network entity, the first management information for the NF entity, and
identify a result of an analysis for the NF entity based on the first management information for the NF entity.

7. The first NWDAF entity of claim 6, wherein the controller is further configured to receive, from the network entity, a first message as a response of the first request message, and
wherein the first message includes at least one of a user equipment (UE) identifier (ID) for the collection of the first management information, an analytic ID for the analysis, or a report period for the first management information.

8. The first NWDAF entity of claim 6, wherein the controller is further configured to:
transmit, to the network entity, a second request message for an intermediate analysis for the NF entity; and
receive, from the network entity, the intermediate analysis for the NF entity as a response of the second request message.

9. The first NWDAF entity of claim 6, wherein the controller is further configured to:
identify a type of the first management information for the result of the analysis.

10. The first NWDAF entity of claim 6, wherein the NF entity corresponds to an access and mobility management function (AMF) entity, a session management function (SMF) entity, or a user plane function (UPF) entity, and
wherein the network entity for collecting the management information corresponds to a second NWDAF entity different from the first NWDAF entity.

11. A method performed by a network entity for collecting management information in a mobile communication system, the method comprising:
receiving, from a first network data collection and analysis function (NWDAF) entity, a first request message for collecting first management information for a network function (NF) entity; and
transmitting, to the first NWDAF entity, the first management information for the NF entity,
wherein a result of an analysis for the NF entity is based on the first management information for the NF entity.

12. The method of claim 11, further comprising:
transmitting, to first NWDAF entity, a first message as a response of the first request message,
wherein the first message includes at least one of a user equipment (UE) identifier (ID) for collecting the first management information, an analytic ID for the analysis or a report period for the first management information.

13. The method of claim 11, further comprising:
receiving, from the first NWDAF entity, a second request message for an intermediate analysis for the NF entity; and
performing the intermediate analysis for the NF entity.

14. The method of claim 13, further comprising:
transmitting, to the first NWDAF entity, the intermediate analysis for the NF entity as a response of the second request message,
wherein the result of the analysis for the NF entity is based on the first management information and the intermediate analysis.

15. The method of claim 11, wherein the NF entity corresponds to an access and mobility management function (AMF) entity, a session management function (SMF) entity, or a user plane function (UPF) entity, and
wherein the network entity for collecting management information corresponds to a second NWDAF entity different from the first NWDAF entity.

16. A network entity for collecting management information in a mobile communication system, the network entity comprising:
a transceiver; and
a controller coupled with the transceiver and configured to:
receive, from a first network data collection and analysis function (NWDAF) entity, a first request message for collecting first management information for a network function (NF) entity, and
transmit, to the first NWDAF entity, the first management information for the NF entity,
wherein a result of an analysis for the NF entity is based on the first management information for the NF entity.

17. The network entity of claim 16, wherein the controller is further configured to:
transmit, to first NWDAF entity, a first message as a response of the first request message, and
wherein the first message includes at least one of a user equipment (UE) identifier (ID) for collecting the first management information, an analytic ID for the analysis or a report period for the first management information.

18. The network entity of claim 16, wherein the controller is further configured to:
receive, from the first NWDAF entity, a second request message for an intermediate analysis for the NF entity; and
perform the intermediate analysis for the NF entity.

19. The network entity of claim 18, wherein the controller is further configured to:
transmit, to the first NWDAF entity, the intermediate analysis for the NF entity as a response of the second request message, and
wherein the result of the analysis for the NF entity is based on the first management information and the intermediate analysis.

20. The network entity of claim 16, wherein the NF entity corresponds to an access and mobility management function (AMF) entity, a session management function (SMF) entity, or a user plane function (UPF) entity, and
wherein the network entity for collecting management information corresponds to a second NWDAF entity different from the first NWDAF entity.
